(19) United States
(12) Patent Application Publication
(10) Pub. No.: US 2009/0132724 A1
(43) Pub. Date: May 21, 2009

(54) SYSTEM AND METHOD FOR NETWORK INFRASTRUCTURE AND INTERNET APPLICATIONS WITH P2P PARADIGM

(76) Inventors: Wei K. Tsai, Irvine, CA (US); Albert Lee, Aliso Viejo, CA (US)

Correspondence Address: MAIER & MAIER, PLLC, 1000 DUKE STREET, ALEXANDRIA, VA, 22314, US

(21) Appl. No.: 11/818,969

(22) Filed: Mar. 16, 2007

Related U.S. Application Data
(63) Continuation-in-part of application No. PCT/US2006/003563, filed on Sep. 13, 2006.
Application No. PCT/US2006/003563 is a continuation-in-part of application No. 11/497,298, filed on Aug. 2, 2006.

(51) Int. Cl. G06F 15/16

(52) U.S. Cl. 709/238

(57) ABSTRACT

A system including a plurality of c-nodes, and one or more source terminal nodes and one or more destination terminal nodes connected to an IP network. The source node terminal nodes send IP packets over the plurality of c-nodes to the destination terminal nodes to arbitrary groups of the destination terminal nodes.

### FIELD OF THE INVENTION

The present invention generally relates to a system and method for networking platform to support P2P applications, and more particularly, to a networking protocol structures to efficiently support P2P application paradigm wherein the control of what to share, who to share, and how to share, across different geographical, service, social grouping, and technological boundaries, are enabled.

### BACKGROUND OF THE INVENTION

The present invention is construed to support a particular vision of the Internet: Web 3.0. Web 1.0 is characterized by “content of the big business, by the big business, for the big business.” In Web 2.0, there is a sea change: it is characterized by “content of the big business, by the people for the people.” Originally, Web 2.0 was meant to have content owned by the people. However, numerous successful Web 2.0 sites have been bought out by the big businesses, losing their independence.

With the advent of Web 2.0, the supporting networking paradigm of P2P (peer-to-peer) rose to the occasion. Central to the P2P networking is the concept of sharing. Sharing is possible because most individuals and institutions employ the concept of over-provision to reserve resources. Almost in all cases, there will be left over capacities or resources that are unused.

The resources shared in the P2P paradigm can be files, data, bandwidths, computing resources, storage, and etc. There exist numerous methods and protocols for P2P sharing and it is estimated that 60% of traffic today in the Internet is P2P induced. Prominent examples include grid computing, Napster, and Skype.

In the co-pending application Ser. No. 11/497,298, the concept of zero opportunity cost (ZOC) resource was introduced. If a resource has been fully paid for, then the opportunity cost of not using it is zero; on the other hand, the resource could still be used to generate values for non-owners of the resource. Such a resource will be called a ZOC resource.

In the co-pending application Ser. No. 11/497,298, the method to exploit large scale ZOC communication bandwidths and computing capacities is referred to as EPP (enterprise P2P). In the co-pending provisional application 60/885,569, the concept of MSVN (multi-service virtual network) was introduced.

An MSVN is designed as a light weight replacement to an IMS (IP multimedia subsystem) service network. MSVN is differentiated from other service platforms, by the following unique feature set: (1) P2P exploitation of ZOC resources, (2) being an edge network technology, (3) being a virtual network built on top of other networks, (4) convergence of all access technologies below IP-layer, (5) integration of all applications over IP transport, (6) distributed user control of access, and (7) cross-platform customizable multi-service.

The present invention is a generalization of the network platform for MSVN; furthermore, its main goal is to support Web 3.0. Therefore, the name Internet3 is adopted as the name of the current invention.

As of this writing, there exist two claims to the name Web 3.0: one is the famous Semantic Web lead by Berners-Lee, and the second is community web platform called NuWeb led by Sun Wu. The Semantic Web project, while being extremely attractive, bears the high risks associated with natural language processing (NLP), which has a complexity level that is intractable. Such intractability has caused numerous projects to fail, and an early failed example is the “5th generation computer” led by the Japanese government. One reason for the failure is attributed to the difficulty of knowledge processing, a cousin of NLP. The success of the Semantic Web and its main technology, Web Ontology Language, are yet to be seen as of this writing.

The present invention, on the other hand, being more a networking innovation than a high level knowledge innovation, is designed to support the NuWeb version of the Web 3.0, which is a most generalized and natural application platform for P2P.

The main differentiator of NuWeb from other Web3.0 is the concept of control by user. NuWeb insists on user control two broad categories of actions: (1) What to share, and (2) Who to share.

In rest of the present disclosure, NuWeb will be considered as the Web 3.0.

Interesting observations can be made by comparing the present invention, Internet3, against the previous generations of Internet, Internet1 and Internet2, alongside with the development history the Web.

The comparison can be summarized in FIG. 1. There is a definite trend today that the Web is undergoing a social revolution. In the past, the Web has been dominated by the big businesses. Even of this writing, in the era of Web 2.0, numerous Web 2.0 sites have been bought by the big businesses. The owners of these sites are legally allowed to change the content without the content authors' consent. Therefore, in the third generation, where Internet3 is concerned, the key differentiator is that the user (people) must exercise control on content access and content distribution.

While there exist numerous P2P networking platforms, the present invention, Internet3, is distinguished by the dominant role played by the mesh access points, and ordinary wireless access points.

Another distinguishing feature of the present invention is that the P2P grouping is assumed to be accomplished by a higher layer.

Most researchers and P2P infrastructure designers assume arbitrary grouping. This view actually is against the main theme of Web 2.0 and 3.0. Under Web 2.0 and 3.0, P2P grouping of peers is based on social behavior. Therefore, grouping should be done by the applications and users of the same interests. Therefore, the network layer should assume that the grouping (discovery, queries, and etc.) should already be done.

What is more important is to enhance optimal sharing. Optimal sharing would require some kind of standards. This is similar to the invention of container. The use of standardized containers saves worldwide commerce a tremendous amount of money.

In networking, this is translated into discretization of resources: cycles, cycles/sec, bits, bits/sec, and etc.

Furthermore, users can specify how firm they are willing to share. Some users may be willing to share even if they might want to use their pay-per-period capacities. This is equivalent to a wholesaler. If a user has a large quantity of a specific type of resources, he may be willing to let it be shared if the price is right.

How to share is another important consideration. Therefore, according to one aspect of the present invention, selective multicast, selective aggregation of ZOC capacities, and selective use of ZOC capacities are important; another differentiator of the present invention. The selection criteria will be described in greater detail in later part of the present disclosure.

Yet another distinguishing feature of the present invention is the use of unique combination of (1) mesh access points, (2) regular access points, (3) sensors to enable P2P networking functionalities of Internet3.

While there are numerous way to enable P2P functionalities, and more particularly, the functionalities needed for Web 3.0, the usual way of thinking is to use full function computing devices such as desk-top or lap-top computers, PDAs, and etc. On the other hand, the present invention uses access points, a device which is most likely not considered as a host, and sensors, often are too small to be manufactured as an IP device.

One problem associated with USN (ubiquitous sensor networks) is that it costs a lot of money to build an infrastructure to relay the data collected by the tiny sensors deployed in the USN. Without a widely deployed and inexpensive communication infrastructure to relay the sensor data, USN is quite useless as the sensors are no longer ubiquitous. One distinguishing feature of the present invention is that USNs are widely and simply deployed alongside with the access points, according to a preferred embodiment.

### SUMMARY OF THE INVENTION

It is, therefore, an object of the present invention to provide a system and method to enable P2P sharing and the functionalities of Web 3.0.

It is another object of the present invention to provide a system and method to relay the data collected by ubiquitous sensors to the Internet through the access points in an embodiment of the present invention.

It is another object of the present invention to utilize the data collected by the sensors to be as trigger points for some functions desired by users of the Internet or a private network wherein the user is connected.

It is another object of the present invention to provide a system and method to enable two or more peers in the same P2P group to share ZOC resources through standardized resource allocation.

In accordance with another aspect of the present invention, there is provided a method to efficiently match the supply and demand for ZOC resources within a group of P2P users.

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 shows how evolution of Web 1.0 through 3.0 compared against Internet.

FIG. 2 shows mesh layer on top of access layer in the same mesh node realized both by regular WiFi access points.

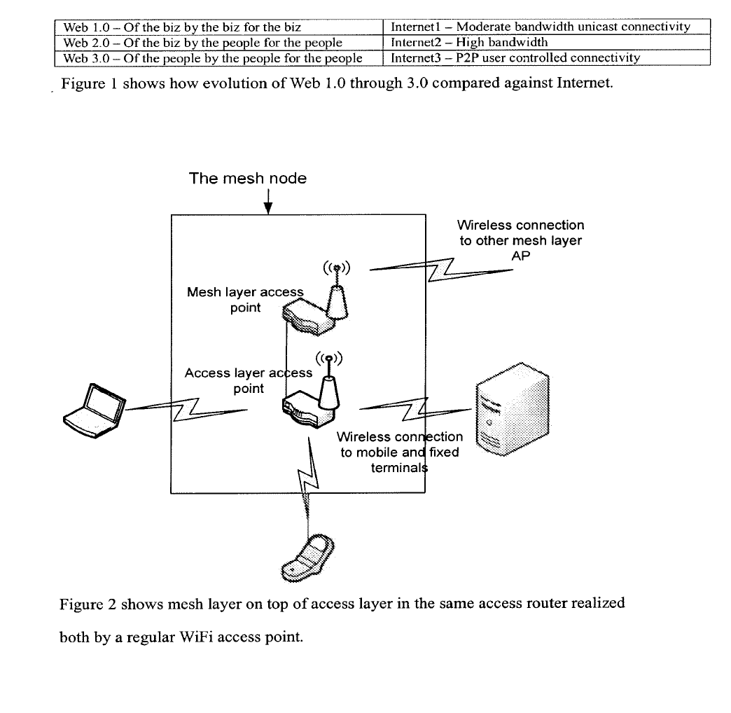

### DETAILED DESCRIPTION OF THE PRESENT INVENTION

The present invention is a broad system and method to enable P2P sharing of ZOC resources among the users in a community. A preferred embodiment of the components of the architecture include: (1) sensing layer, (2) access layer, (3) mesh layer, and (4) control layer.

The four components cited above can be implemented using software, and software insertion into commercial off-the-shelf terminal devices and boxes.

According to a preferred embodiment of the present invention, the sensing layer may consist of partial functionality sensors, full functionality sensors, or the sensing and measuring functions implemented in a host. In one embodiment, a 6LoWPAN sensor at the door of a house may detect that a stranger has appeared on the front door. The sensor will then signal this potential threat to a nearest WiFi access point. The access point will in term instruct another sensor, this time an IP-camera at the front door to take a picture of the stranger and forward the picture to the man of the house.

According to another preferred embodiment, all the currently available ZOC resources are collected from all the peers in the same user community and put into a distributed database. Note that all the members of the community do not have to be physically very near to each other. Then the available ZOC resources will be arranged to be consumed via the control layer by the needy users who are in need of some of the available ZOC resources.

From the above description, the sensing layer in the present invention is an abstraction of devices that provide feedback information. These devices can be actual sensors, or sensing functions in physical devices.

Another motivation for the sensing layer is that small sensors need to be relayed to the users who can benefit from the data. In accordance with one embodiment of the present invention, small sensors are equipped with computing and communication power to be 6LoWPAN compliant. Then the small sensors will forward their measured data directly to a nearby sensor access point. In another embodiment, a sensor access point is integrated into WiFi access points.

Above the sensing layer lies the access layer. According to a preferred embodiment, the access layer consists of wireless or wireline access points. Examples of access points can be: WiFi access points, WiMax or WiBro access points, Ethernet access points, and etc.

According to a preferred embodiment of the present invention, WiFi access points are of particular interest as they are often bundled with routers. The routers are equipped with IP-routing (hence computing) capability. These access points are by convention always-on (power and connection is never turned off), they represent the best ZOC computing and communication resources.

According to another preferred embodiment of the present invention, access points are bundled with an IP-router form the backbone of ZOC computing and communication ZOC resources.

According another preferred embodiment, peers express their ZOC resources in terms of discrete increments; the size of the increment has been agreed upon and known to all the peers. The ZOC resources are forwarded to distributed locations where all peers can access this information. The ZOC resource list from a peer may contain restrictions on who can use the ZOC resources it owns, at what price it is willing to trade with other peers, and how these resources can be used. The ZOC resource descriptions may include time expiration, limitations, and other specific information pertaining to the use of the particular ZOC resource.

In another preferred embodiment, a trading platform is implemented to enable a marketplace to trade ZOC resources between and among the users (peers) with available and tradable ZOC resources.

Above the access layer lies the mesh layer. According to a preferred embodiment, the mesh layer consists of mesh access points, which are called mesh node in the present invention. A mesh node, according to this embodiment, is a two-layer device. The top layer is a pure mesh IP device wherein all the mesh routing, flow control, network configuration, and management functions are being performed. The bottom layer is an access router, wherein individual end hosts can be connected via the IP protocol; the connections can be wireless (for example, WiFi or WiBro), or wireline (for example, Ethernet).

According to the above embodiment, there is a clean separation between the mesh functionalities and access point functionalities in the same device at two different layers.

Above the mesh layer lies the control layer. According to a preferred embodiment, the control layer will take feedback information from the sensing layer. Recall that the sensing layer is an abstraction; it can take measurements from the access layer, mesh layer, and the attached sensors which might be connected to a USN and an access point.

According to a preferred embodiment, the control layer will conduct selective multicast, selective aggregation, and selective use of the ZOC resources. Each item of ZOC resource comes with a list of restrictions and conditions. The responsibility of the control layer is to enforce these restrictions and conditions. Thus, as some resources are to be shared (for examples, some photo-images from a user are to be shared); they will be selectively multicast to the allowed peers. An example of selective use of ZOC resources is described below: A user may have turned off its desktop computer and yet another user has a powerful access router that can be used to publish content via the HTTP protocol. Then, under the condition that the ZOC conditions and restrictions are satisfied, the first user can transfer his content to the second user's access point and continue to publish his content even after his desktop computer is turned off.

According to a preferred embodiment, both the mesh layer and the access layer in the same mesh node are realized regular access points. For example, the mesh layer is realized by a WiFi access point with an IP router, wherein the radio is only responsible for communication between mesh nodes. The access layer is realized by another WiFi access point with an IP router, wherein this router is responsible for the mobile or fixed terminals to access the Internet. The upper layer and lower layer are connected by an IP path internally. The upper layer has a public IP address and the lower layer implements a private network with a firewall. The upper layer public IP address can be also be a private IP address in an alternate embodiment.

1. A system, comprising:
a plurality of c-nodes;
one or more source terminal nodes connected to an IP network; and
one or more destination terminal nodes connected to said IP network,
wherein said source terminal nodes send IP packets over the plurality of c-nodes to said destination terminal nodes to arbitrary groups of said destination terminal nodes.
